(19) United States
(12) Patent Application Publication
(10) Pub. No.: US 2011/0307631 A1
(43) Pub. Date: Dec. 15, 2011

(54) SYSTEM AND METHOD FOR PROVIDING ASYNCHRONOUS DATA COMMUNICATION IN A NETWORKED ENVIRONMENT

(76) Inventors: Sangbong Park, Union City, CA (US); Cheng Zhang, Saratoga, CA (US); Hyun Jin Cho, Cupertino, CA (US); Lindsay John Lawrence, Richmond, CA (US)

(21) Appl. No.: 13/155,717

(22) Filed: Jun. 8, 2011

Related U.S. Application Data
(60) Provisional application No. 61/353,134, filed on Jun. 9, 2010.

(51) Int. Cl. G06F 15/16

(52) U.S. Cl. 709/248

(57) ABSTRACT

A method and system for providing asynchronous data communication between a plurality of devices in a networked environment is disclosed. A user using a first device views view media content received from a first content provider of a plurality of service providers. At a request of the user, a message including a data link to the media content is generated and asynchronously sent to a second device via a network. The data link contained in the received message on the second device is used to retrieve the media content from a second content provider. Various action commands contained in the message are used to control the operation of the media content on the second device.

The present application claims the benefit of the earlier filing date of U.S. Provisional Patent Application No. 61/353,134 entitled “System and Method For Providing An Asynchronous Multi-Media Service In A Networked Environment” and filed on Jun. 9, 2010, which is hereby incorporated by reference in its entirety.

### FIELD

The field of the invention relates generally to asynchronous data communication, more particularly, to a system and method for providing asynchronous multi-media communication in a networked environment using a software module on communication devices.

### BACKGROUND

Social networking and social commerce are becoming popular as more users connect to social media sites and spend more hours to interact with other people. Various media tools are available for social networking and interaction with others such as smart phones, smart TVs, tablet computers, set-top boxes, and various forms of network and communication devices.

Conventional broadcasting media content delivery platform is quickly transforming into an interactive media platform enhanced with social content and networking capability. For example, smart TV viewers can access and enjoy a plethora of media, internet TV, over-the-top content as well as on-demand streaming media from various content providers or social network sites. The viewers can further read others' reviews and comment on interested topic and leave their own ratings on a viewed content to help other's choice, achieving a new level of social interactivity that was impossible on conventional media content delivery platforms.

The landscape of social interaction with other peers in a networked environment continues to change with the development of content delivery systems and technology. More users use their smart phones or tablet PCs while watching a TV show or movie on their TV. More TVs are connected to the Internet or as a client device of a home network. Users also want to share their content, experience and preference, and/or opinions on specific content or topic with other peers. These social aspects of the social networking sites attract more users and marketers. Conversely, the number of these social media sites continues to increase as more users spend time on these social networking sites.

The new content delivery system enhanced with social interaction generates enormous amount of market opportunity. Users' interest on various topics, level of social activities, and behavior patterns generate enables online marketers to collect a great deal of user data, and the complied user data on a very large scale user base is particularly useful to promote sales, suggestions, and information on products while users view media content. As more users interact with other peers and spend more time on these social media sites, marketers can provide an efficient and cost effective way of marketing, specifically targeting focused viewers with similar interest and behaviors.

The present invention provides enhanced content viewing experience and solutions to share media content among viewers by providing efficient and interactive data communication.

### OBJECTIVES AND SUMMARY

A method and system for providing asynchronous data communication between a plurality of devices in a networked environment is disclosed. A user using a first device views view media content received from a first content provider of a plurality of service providers. At a request of the user, a message including a data link to the media content is generated and asynchronously sent to a second device via a network. The data link contained in the received message on the second device is used to retrieve the media content from a second content provider. Various action commands contained in the message are used to control the operation of the media content on the second device.

In broad embodiment, the present subject matter is directed to a method and apparatus directed to providing an integrated asynchronous multimedia service using a client device and a server.

In one embodiment of the present invention, a technique is provided for providing asynchronous data communication in a networked environment, comprising:
viewing media content received from a first content provider at a first device;
generating a message including a data link to the media content;
delivering the message asynchronously to a second device via a network; and
allowing the second device to retrieve the media content via the data link contained in the message from a second content provider.

Another embodiment of the present invention is directed to a system for providing asynchronous data communication, comprising:
a plurality of content providers;
a first device adapted to view media content available at a first content provider of the plurality of content providers and generate a message containing a data link to the media content;
a second device adapted to receive the message generated by the first device and retrieve the media content via the data link contained in the message,
wherein the message is asynchronously delivered to the second device.

The above and other preferred features described herein, including various novel details of implementation and combination of elements, will now be more particularly described with reference to the accompanying drawings and pointed out in the claims. It will be understood that the particular methods and circuits are shown by way of illustration only and not as limitations of the claims. As will be understood by those skilled in the art, the principles and features of the teachings herein may be employed in various and numerous embodiments without departing from the scope of the claims.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates an exemplary asynchronous data communication system in a networked environment, according to one embodiment;

FIG. 2 illustrates a detailed system diagram of a sender interacting with a receiver and content providers, according to one embodiment;

FIG. 3 is a flowchart depicting functions and operations of a sender, according to one embodiment;

FIG. 4 illustrates a system diagram depicting operations of a receiver interacting with a sender and media data, according to one embodiment;

FIG. 5 illustrates life cycle processes of a job manager in response to request messages from a sender, according to one embodiment;

FIG. 6 illustrates a flowchart depicting job dispatch, assignment, and process occurring at a receiver; and

FIG. 7 illustrates a data flow diagram passing a data link from a sender to other peers for sharing or recommending media data, according to one embodiment;

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

A method and system for providing asynchronous data communication between a plurality of devices in a networked environment is disclosed. A user using a first device views view media content received from a first content provider of a plurality of service providers. At a request of the user, a message including a data link to the media content is generated and asynchronously sent to a second device via a network. The data link contained in the received message on the second device is used to retrieve the media content from a second content provider. Various action commands contained in the message are used to control the operation of the media content on the second device.

Each of the features and teachings disclosed herein can be utilized separately or in conjunction with other features and teachings to provide a method and system for providing asynchronous data communication in a networked environment. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for purposes of explanation only, specific nomenclature is set forth to provide a thorough understanding of the present invention. However, it will be apparent to one skilled in the art that these specific details are not required to practice the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, design verification systems such as a hardware emulator, simulator, and hardware-accelerated simulator systems, or testers providing scan inputs to such design verification systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the invention as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

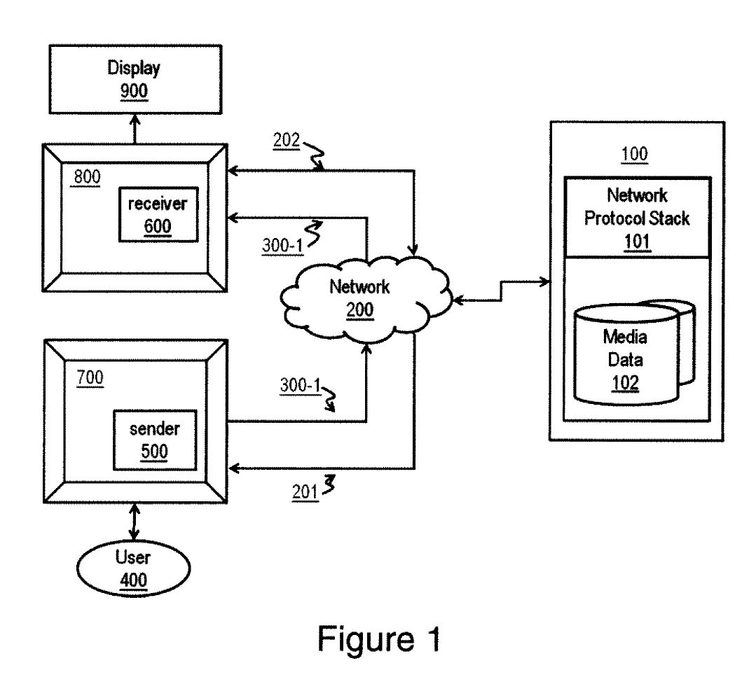

FIG. 1 illustrates an exemplary asynchronous data communication system in a networked environment, according to one embodiment. User 400 interacts with sender 500 (also referred to as data communication module) on sender device 700. Sender device 700, receiver device 800, and one or more content providers 100 are connected via network 200 via a wired or wireless link. Network 200 may be the Internet, an intranet, or any type of network enabling transmission and reception of data via an appropriate medium.

At a request from user 400, sender 500 provides an access to multimedia data 102 or a piece of information related to multimedia data 102 available at one or more content providers 100. In one embodiment, content providers 100 are multimedia data servers or media content providers such as YouTube, Hulu, Netflix, and Amazon VOD.

According to one embodiment, sender device 700 is a computer or an electronic device with a built-in processor, memory, and display screen (e.g. a laptop, a tablet PC, a smart phone, a set-top box). Sender 500 receives a request from user 400 and interacts with a particular content provider 100 to access the requested media data 102. In one embodiment, sender 500 is an independent software module running on sender device 700. In another embodiment, sender 500 is incorporated into another software module in sender device 700.

When sending a request for media data 102 out to sender 500, user 400 also passes the information associated with the requested media data 102 to a designated receiver device 800. For example, user 400 wants to watch media data 102 on a separate display 900 instead of or in addition to the generic display of sender device 700. Alternatively, user 400 forwards media data 102 to a remote site, and another user on the remote site watches media data 102 on display 900.

According to one embodiment, sender 500 passes to receiver device 800 a message 300-1 that contains data link of media data 102, action command(s), and other information required to process the message 300-1. Receiver 600 (also referred to as multi-media data communication module) on receiver device 800 receives the message 300-1 and processes the media data 102 according to the action command(s). If the action command is a data retrieval command, receiver retrieves media data 102 from content provider 100. The data retrieval command arrives at the corresponding content provider 100 containing media data 102. Media data 102 is sent to receiver device 800 when network protocol stack 101 of content provider 100 executes the retrieval request from receiver 600.

According to one embodiment, sender device 700 displays streaming content from one or more of content providers 100. Content may be displayed on a browser (e.g. Internet Explorer, Firefox, Google Chrome, Safari), a customized graphical user interface, or a media player. The displayed content contains multimedia data links directly or indirectly to media data 102 that is available from content provider 100 (e.g. YouTube, Hulu, Netflix, Amazon VOD). In one embodiment, the streaming content provider 100 that streams content to sender device 700 contains media data 102. In another embodiment, media data 102 is hosted in a different content provider from the streaming content provider 100.

User 400 selects one of the displayed data links and an action command. In response to user 400's selection, sender 500 generates a corresponding message 300-1 and sends it via network 200 to receiver device 800. Since sender 500 sends only information of media data to receiver 600 without sending the entire media data content, the connection between sender device 700 and receiver device 800 can be intermittent, and there is no need for a persistent connection therebetween. In addition, the amount of data exchanged between sender device 700 and receiver device 800 is minimal in the form of a message, and sender 500 merely communicates with receiver 600 to instruct receiver device 800 to execute a command associated with the media data as indicated in the message. While sender 500 is sending the message 300-1 to receiver 600, user 400 continues to browse the content, play media files, send another message, or interacts with sender device 700 to use other services that sender device 700 provides.

Receiver device 800 is a media delivery device, a computer, or an electronic device with a built-in processor and memory that is capable of displaying multimedia content. In one embodiment, receiver device 800 may be connected to another display device 900 using an A/V cable such as a component/composite/HDMI and/or audio cable. In another embodiment, receiver device 800 and display 900 are collocated in the same device and performed by separate functional modules. Receiver 600's main function is to fetch media data 102 from the designated multimedia server 100 according to the message received from sender 500. Multimedia server 100 supports multiple network interface protocols such as NFS (network file system), RTSP (real time streaming protocol), CIFS (common internet file system), http, ftp. Media data 102 is located behind network protocol stack 101 and may include, but not limited to, movie, music, article, and photo files. Receiver 600 decodes fetching or fetched media data 102 and displays it on display 900. After the displaying the fetched media data 102 or when receiver 600 instructs so, receiver 600 sends a status report of media data via 201. In one embodiment, the status report may be sent back to sender 500 at his/her request when sending the message 300-1. In one embodiment, sender 500 and receiver 600 are collocated in the same device as different functional modules. The generation and delivery of the message 300-1, fetching of media data 102, and/or reporting the status occur automatically by default but can be configured to be updated or modified at user 400's intervention.

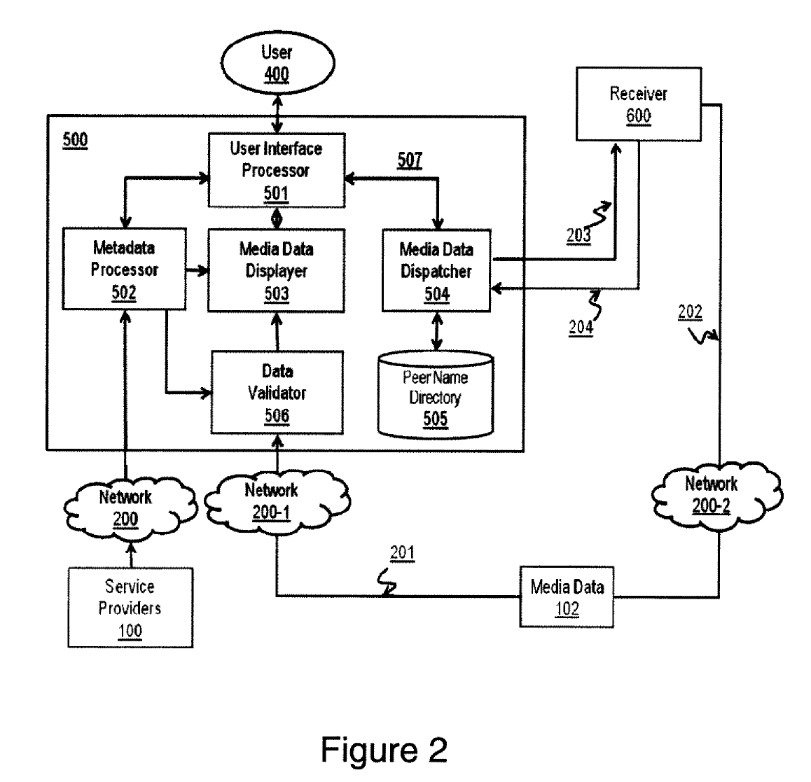

FIG. 2 illustrates a detailed system diagram of sender 500 interfacing with receiver 600 and content providers 100, according to one embodiment. User 400 interacts with sender 500 using a touch screen, a keyboard, a stylus, and/or a mouse through a user interface provided by user interface processor 501. User interface processor 501 provides updated content to user 400 on its graphical interface based on the continuous interaction with other modules of sender 500 such as metadata processor 502, media data displayer 503, and media data dispatcher 504. Metadata processor 502 processes and, if necessary, reformats the metadata received from metadata servers or content providers 100. The received metadata contains a link to the associated media data 102. Media data browser 503 identifies the link and validates the availability and accessibility of the linked media data 102 using data validator 506. When user 400 selects media data 102 to send to receiver 600, media data dispatcher 504 confirms the location and authentication information of receiver 600 by querying from peer name directory 505 that contains a list of registered available receivers on network 200. Media data dispatcher 504 passes a message token to receiver 600 (203) and polls to collect the status of receiver 600 (204).

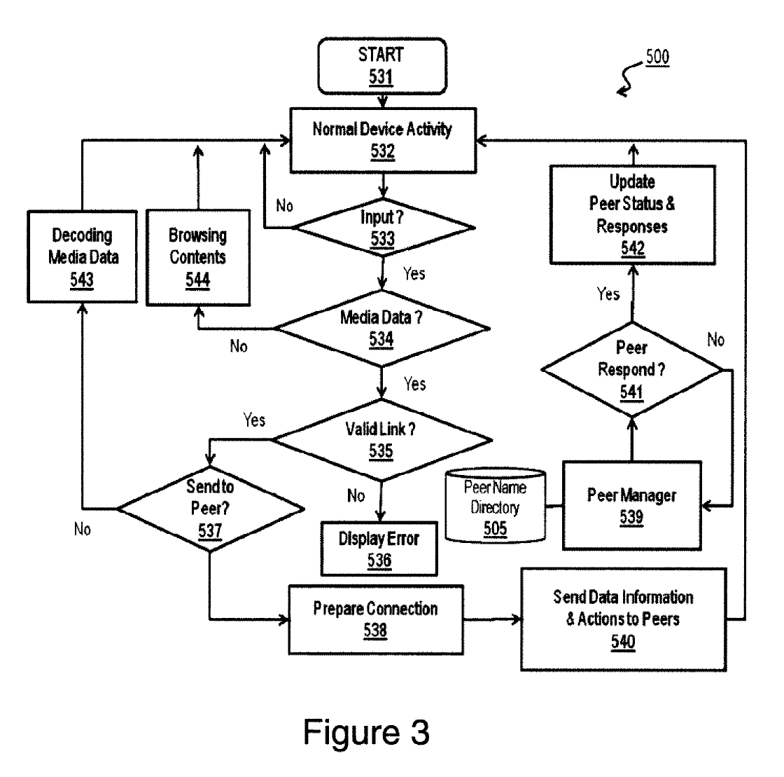

FIG. 3 is a flowchart depicting functions and operations of sender 500, according to one embodiment. Normal device activity 532 refers to, but is not limited to, refreshing UI, updating content, displaying messages, processing user inputs, tracking user behaviors, etc. Sender 500 routinely searches for peer receivers 600 and saves the receiver information into peer name directory 505. When user 400 issues an input event using an input device (e.g., a mouse, a keyboard, a touch screen, and a stylus), the event is passed through input (step 533). The passed event is classified into two categories; browsing content and sending a message to a designated peer receiver 600 (step 537) that exists in peer name directory 505. Browsing content is defined as, but not limited to, general web browsing, page navigation, zooming in/out, media playing, handling of application window, and so on. An input event that is not specific related to a media data 102 is considered to be an action command for browsing content (step 544). Media data 102 requested by the message is validated in step 535. Multiple points are checked, for example, whether the location of media data 102 is available, whether the media data 102 is readable, and/or an authentication is needed. With invalid media data 102, the event ends with a display of an error message on the device screen (step 536). If the media data 102 has a valid link (step 535), it is decoded and displayed (step 543). The media data link may be passed to other peers (step 537).

For sending a media data link, a message is generated and sent to the designated receiver 600 (step 538). The message contains, but not limited to, a message identification number, an action command, a media data link, an identification number of receiver 600. Exemplary actions commands are, but not limited to, “list”, “delete”, “stop”, “pause”, “fast forward”, “fast rewind”, and “play”. Peer manager 539 keeps polling the status of the receivers 600 and reports the responses (step 542) and displays the status on the application screen (step 532).

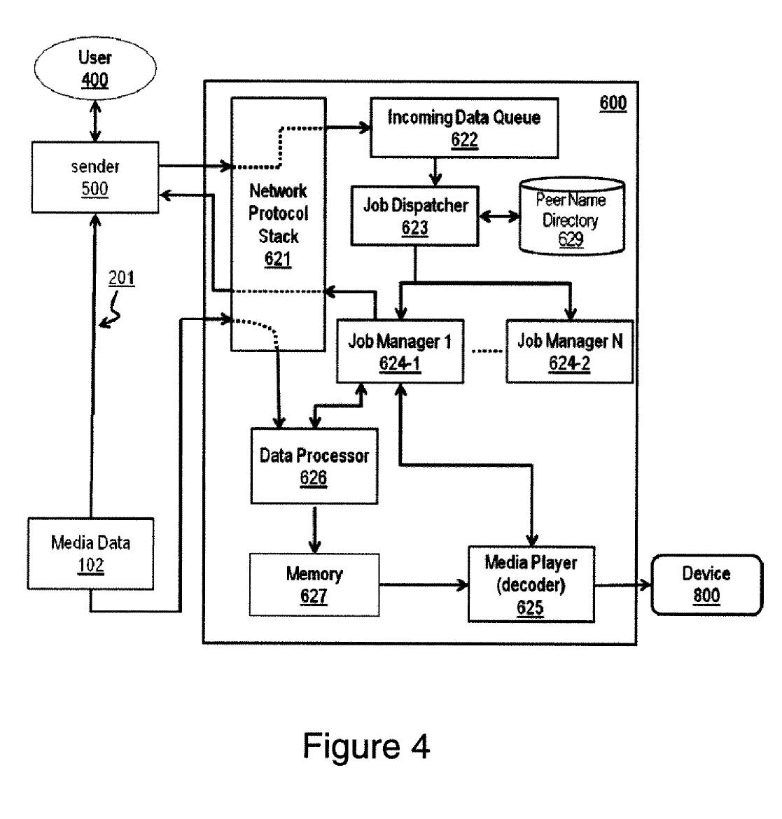

FIG. 4 illustrates a system diagram depicting operations of a receiver interacting with a sender and media data, according to one embodiment. Receiver 600 retrieves media data 102 that is available at multimedia server 100 in response to sender 500. According to one embodiment, receiver 600 asynchronously interacts with sender 500 such that no persistent connection is required between sender 500 and receiver 600. Receiver 600 contains network protocol stack layer 621 that manages a network interface to an external system. Network protocol stack layer 621 supports various network transport protocols including http, NFS, CIFS, RTSP, and ftp.

When a new message arrives from sender 500, through network protocol stack 621, the message is temporarily stored in incoming data queue 622. Job dispatcher 623 manages resources of job managers 624. Job dispatcher 623 takes a request message from the queue and checks if it came from one of the registered senders 500 by referring to peer name directory 629. If sender 500 is not registered, job dispatcher 623 discards the message or asks user to verify the identity of sender 500. When the message is validated, job dispatcher 623 assigns the message to job manager 624.

Job manager 624 parses the message and identifies the action command, media data link and the identity of sender 500. When configured so or sender 500 requested, job manager 624 responds to sender 500 with assignment identification number and assignment status after parsing the message. Depending on the action command in the message, job manager 624 calls data processor 626 to start fetching media data 102 from multimedia server 100 and/or runs media player 625 with the buffered media data 102 in memory 627. While fetching media data 102, job manager 624 monitors fetching progress and executes media player 625 to output media data to receiver device 800 or display 900. If the action command is a status report command, job manager 624 reports its status with the assignment identification number.

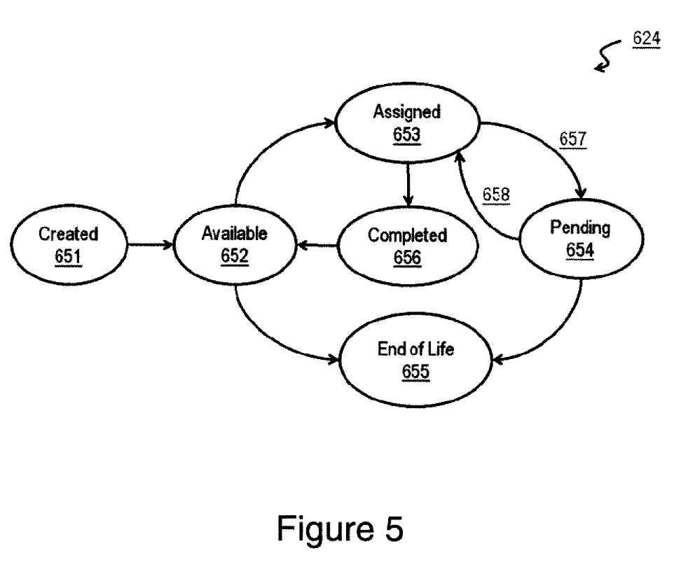

FIG. 5 illustrates life cycle processes of job manager 624 in response to request messages from sender 500, according to one embodiment. In this example, job manager 624 is in one of the six available statuses: created, available, assigned, pending, completed, and killed (end of life). Job manager 624 is monitored and managed by job dispatcher 623. In step 651, job manager 624 is created by job dispatcher 623 with minimal resources. Job manager 624 is populated in a pool of job managers and its status is set to “available” 652. When there is a message in incoming data queue 622, job dispatcher 623 selects a job manager 624 from the pool and assigns the message to it. The status of the assigned job manager 624 is changed to “assigned” 653. When the message is successfully executed or terminated by job dispatcher 623, the status of the job manager 624 is changed to “completed” 656. The job manager 624 is then repopulated to the pool with a status of “available” 652. When a job manager 624 runs into an issue in an “assigned” status in 657, the status of job manager 624 is changed to “pending” 657 and is hibernated. Job dispatcher 623 may re-execute the job manager 624 after resolving the issue in 658 or kill the job manager in 655. To distribute and maintain the level of work load and to avoid overflowing the number of messages in incoming data queue 622, a certain number of job managers 624 are maintained in the pool. When a job manager in the pool is killed, a new job manager is created in step 651 to replace the killed job manager.

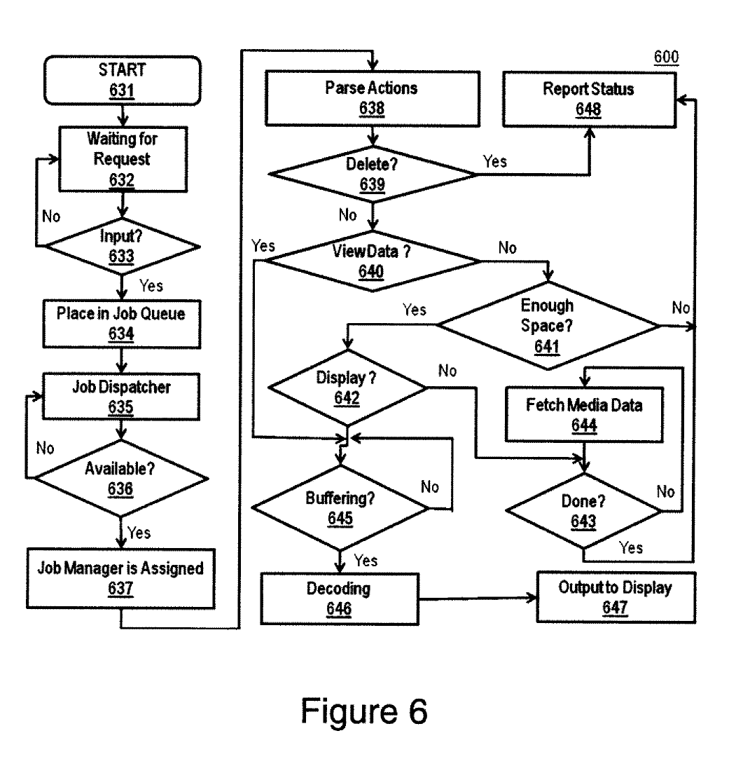

FIG. 6 illustrates a flowchart depicting job dispatch, assignment, and process occurring at receiver 600, according to one embodiment. Starting from 631, receiver 600 waits for a message from sender 500. A received message 632 is stored in job queue 634. Job queue 634 is temporary and consumed by job dispatcher 635. Job dispatcher 635 selects a message among received messages in job queue 634 in the order of their receipt or priority, and assigns the selected message to an available job manager 624 in steps 636 and 637. Job dispatcher 635 monitors resources of job managers 624 and manages job managers 624. Job manager 624 parses the assigned message in 638 and checks its action command in steps 639 and 640.

Job manager 624 processes various kinds of action commands. If the action command is a “delete” command (step 639) requesting to delete a media data file, job manager 624 assigned in 637 stops the current fetching process linked to the media file and executes the deletion. The result of the execution is reported back to sender 500 via report status block 648. If the action command is a “view” or “fetch” command of a media data file (step 640), job manager 624 checks if the media data is already fetched, currently being fetched. If the media data is not yet fetched, job manager 624 tries to secure a storage space in 641 from the currently available space in memory 627. When there is not enough space, job manager 624 reports a status to sender 500 via report status block 648 and changes its status from “assigned” to “pending”. Job dispatcher 635 may awake job manager 624 from “pending” status by allocating enough storage space so that job manager 624 in the “assigned” status starts fetching the media data (steps 643 and 644). Job manager 624 starts decoding when the fetched data in memory 627 is enough buffered (step 645). Network speed, data resolution, and/or data size may be considered to determine a proper buffering size. The media data is decoded in 646 and is output to display in 647. Sender 500 may request to retrieve status report 648 from receiver 600 that may contain, but not limited to, a fetching progress, the media file name, current available resources in receiver 600, etc. Such a request for status report may be made in the original message containing the action command or in a separate request message to receiver 600.

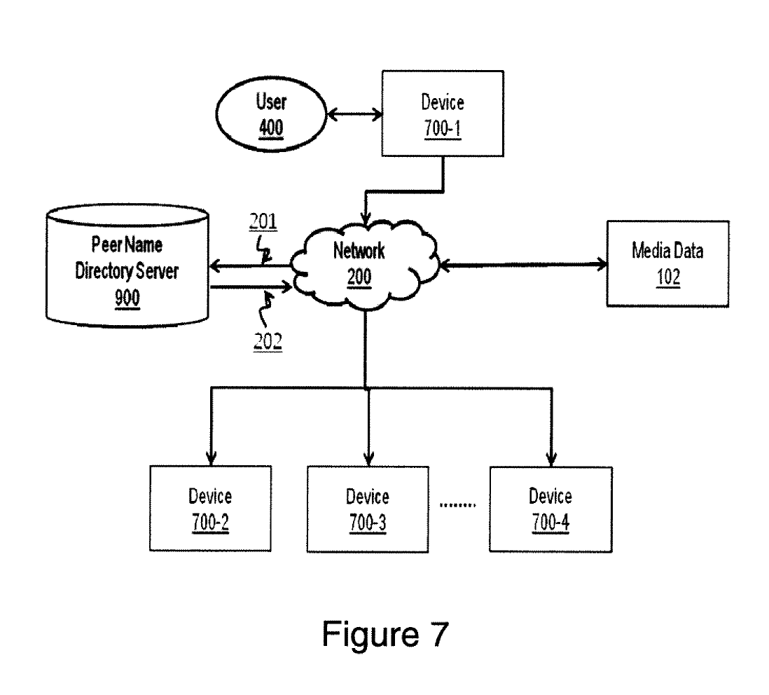

FIG. 7 illustrates a data flow diagram passing a data link from sender 500 to other peers for sharing or recommending media data, according to one embodiment. In this example, media data is shared or recommended by sender 500 between peer devices 700. Each peer device 700 has its own sender 500 and receiver 600 and connected to each other via network 200. Central peer directory name server 900 manages and routinely updates the list of registered devices 700. User 400 shares or recommends a media data displayed on his/her own device 700-1 to other registered peer devices 700-2, 700-3, and 700-4. The shared or recommended media data 102 may have been already displayed, currently being displayed, or is listed on a viewing schedule on display 700-1. As discussed above, sender 500 sends a message to designated peer device(s) 700 that contains, but not limited to, a data link and/or authentication information to peer name server 900 in 201. Peer name server 900 identifies the availability of designated peer device(s) 700 and forwards the message to them when available.

While the foregoing written description described herein enables one of ordinary skill to make and use what is considered presently to be the best mode thereof, those of ordinary skill will understand and appreciate the existence of variations, combinations, and equivalents of the specific embodiment, method, and examples herein. The present subject matter should therefore not be limited by the above described embodiment, method, and examples, but by all embodiments and methods within the scope and spirit of the invention.

A method and system for providing asynchronous data communication between a plurality of devices in a networked environment is disclosed. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

We claim:

1. A computer-implemented method, comprising:
viewing media content received from a first content provider at a first device;
generating a message including a data link to the media content;
delivering the message asynchronously to a second device via a network; and
allowing the second device to retrieve the media content via the data link contained in the message from a second content provider.

2. The computer-implemented method of claim 1, wherein the message contains an action command selected from a plurality of action commands comprising list, delete, stop, pause, fast forward, fast rewind, and play.

3. The computer-implemented method of claim 1, wherein the first content provider and the second provider are the same content provider.

4. The computer-implemented method of claim 1, wherein the second device is validated from a pool of available peer devices listed in a peer name directory server.

5. The computer-implemented method of claim 1, wherein the first and second content providers 100 supports NFS (network file system), RTSP (real time streaming protocol), CIFS (common internet file system), http, and ftp.

6. The computer-implemented method of claim 1, wherein the network is one of the Internet, an intranet, and a dedicated network enabling communication between the first and second devices.

7. The computer-implemented method of claim 1, wherein the second device is coupled to a display for displaying the retrieved media content at the second device.

8. The computer-implemented method of claim 1, wherein the first device comprises a user interface processor, a metadata processor in communication with the first content provider, a media data displayer, a data validator, and a media data dispatcher in communication with the second device.

9. The computer-implemented method of claim 1, wherein the second device comprises a network protocol stack in communication with the first device, an incoming data queue storing incoming messages including said message, a job dispatcher, one or more job managers, a data processor.

10. The computer-implemented method of claim 9, wherein the job dispatcher creates, kills, and changes status of the one or more job managers, and wherein the status of the one or more job managers is identified as one of created, available, assigned, completed, pending, and killed.

11. A non-transitory computer-readable medium having stored thereon a plurality of instructions, said plurality of instructions when executed by a computer, cause said computer to perform:
viewing media content received from a first content provider at a first device;
generating a message including a data link to the media content;
delivering the message asynchronously to a second device via a network; and
allowing the second device to retrieve the media content via the data link contained in the message from a second content provider.

12. The non-transitory computer-readable medium of claim 11, wherein the message contains an action command selected from a plurality of action commands comprising list, delete, stop, pause, fast forward, fast rewind, and play.

13. The non-transitory computer-readable medium of claim 11, wherein the first content provider and the second provider are the same content provider.

14. The non-transitory computer-readable medium of claim 11, wherein the second device is validated from a pool of available peer devices listed in a peer name directory server.

15. The non-transitory computer-readable medium of claim 11, wherein the first and second content providers 100 supports NFS (network file system), RTSP (real time streaming protocol), CIFS (common internet file system), http, and ftp.

16. The non-transitory computer-readable medium of claim 11, wherein the network is one of the Internet, an intranet, and a dedicated network enabling communication between the first and second devices.

17. The non-transitory computer-readable medium of claim 11, wherein the second device is coupled to a display for displaying the retrieved media content at the second device.

18. The non-transitory computer-readable medium of claim 11, wherein the first device comprises a user interface processor, a metadata processor in communication with the first content provider, a media data displayer, a data validator, and a media data dispatcher in communication with the second device.

19. The non-transitory computer-readable medium of claim 11, wherein the second device comprises a network protocol stack in communication with the first device, an incoming data queue storing incoming messages including said message, a job dispatcher, one or more job managers, a data processor.

20. The non-transitory computer-readable medium of claim 19, wherein the job dispatcher creates, kills, and changes status of the one or more job managers, and wherein the status of the one or more job managers is identified as one of created, available, assigned, completed, pending, and killed.

21. A system for providing asynchronous data communication, comprising:
a plurality of content providers;
a first device adapted to view media content available at a first content provider of the plurality of content providers and generate a message containing a data link to the media content;
a second device adapted to receive the message generated by the first device and retrieve the media content via the data link contained in the message,
wherein the message is asynchronously delivered to the second device.

22. The system of claim 21, wherein the message contains an action command selected from a plurality of action commands comprising list, delete, stop, pause, fast forward, fast rewind, and play.
